(19) United States
(12) Patent Application Publication
(10) Pub. No.: US 2012/0216222 A1
(43) Pub. Date: Aug. 23, 2012

(54) Parental Control for Audio Censorship

(76) Inventor: Brant L. Candelore, San Diego, CA (US)

(21) Appl. No.: 13/281,626

(22) Filed: Oct. 26, 2011

Related U.S. Application Data
(60) Provisional application No. 61/445,901, filed on Feb. 23, 2011.

(51) Int. Cl. H04N 7/16

(52) U.S. Cl. 725/28

(57) ABSTRACT

In certain implementations, a television receiver device has an interface configured to receive audio video (A/V) program content and tuning information. A processor is programmed to: tune to a designated program; present an option to tune to the designated program with either a censored or uncensored version of audio; upon receipt of an instruction to tune to the designated program with uncensored audio, tune to a substitute audio stream identified with a secondary packet identifier, where the substitute audio stream substitutes uncensored segments of audio for censored segments of audio. This abstract is not to be considered limiting, since other embodiments may deviate from the features described in this abstract.

### CROSS REFERENCE TO RELATED DOCUMENTS

This application is related to and claims priority benefit of U.S. Provisional Patent Application No. 61/445,901 filed Feb. 23, 2011 which is hereby incorporated by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Several patents and applications exist which deal with the topic of “content substitution” including issued U.S. Pat. Nos. 8,041,190; 7,992,167; 7,882,517; 7,823,174; 7,765,567; 7,742,599; 7,508,942; 7,336,302; 7,302,058 and pending U.S. patent publication number 20060174264. Other applications for parental control include U.S. patent publication numbers 20060130119 and 20070204288. Each of the above patents and applications are hereby incorporated by reference.

Most program providers are required to censor specific language that some people might find offensive to avoid the possibility of a FCC fine. Yet many households are adult only and are annoyed by all the muting (and/or beeping) during programs. The censoring process renders the dialogue hard to follow. Adult viewers might like to hear how the entertainers or artists actually talked and expressed themselves. In some instances it might almost be like delivering an entirely different program.

Almost all the popular television programs on certain networks such as, for example, the Comedy Channel get censored. In addition, many live shows on certain networks such as MTV are censored by use of a short time delay. It should be noted that not only are the spoken words of the masters of ceremonies and various speakers beeped and muted, but censorship is also used when inappropriate words are sung as part of a song. Unfortunately, the muting and beeping can be used so much as to make understanding any dialogue or song difficult.

It is sometimes desirable to render a particular television program in uncensored form. In effect the program may be “unrated” as the actual content of the otherwise censored language is unknown. The producers and performers of the show can decide just how “racy” the uncensored portion of the audio should be. This gives control back to the creators and producers of programs and shows. The viewers can select which version to consume based upon their own preferences and values.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an example of an audio stream consistent with certain embodiments of the present invention.

FIG. 2 is an example of a content editing system consistent with certain embodiments of the present invention.

FIG. 3 is an example of a content distribution system consistent with certain embodiments of the present invention.

FIG. 4 is an example of a flow diagram depicting operation of one implementation consistent with certain embodiments of the present invention.

FIG. 5 is an example of a simulated screen shot of an electronic program guide (EPG) consistent with certain embodiments of the present invention.

FIG. 6 is an example of a simulated screen shot of an EPG with a censored/uncensored selection mechanism consistent with certain embodiments of the present invention.

FIG. 7 is an example of a simulated screen shot depicting password entry in a manner consistent with certain embodiments of the present invention.

FIG. 8 is an example of a flow diagram depicting operation of one implementation consistent with certain embodiments of the present invention.

FIG. 9 is an example of a simulated screen shot of an EPG consistent with certain embodiments of the present invention.

FIG. 10 is an example of a simulated screen shot depicting password entry consistent with certain embodiments of the present invention.

FIG. 11 is an example of a block diagram of a television receiver device or portion thereof consistent with certain embodiments of the present invention.

FIG. 12 is an example of a simulated screen shot of a setup screen permitting a user to opt-in for receipt of uncensored audio in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, or “application” or “app” may include a subroutine, a function, a procedure, an object method, an object implementation, in an executable application, an app, an applet, a servlet, a source code, an object code, a script, a program module, a shared library/dynamic load library and/or other sequence of instructions designed for execution on a computer system having one or more processors.

The term “program”, as used herein, may also be used in a second context (the above definition being for the first context). In the second context, the term is used in the sense of a “television program” or “television show” or simply “show” which are used interchangeably herein. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. In this discussion, the use of the term “Program” is generally consistent with that of the MPEG-2 Systems standard (ISO/IEC 13818-1). An MPEG-2 Program has the associated Elementary Stream components, such as for example one video Elementary Stream and one or more audio Elementary Streams. The term may also be interpreted to encompass commercial spots and other program-like content which may not be reported as a program in an electronic program guide.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As previously noted, almost all of the popular shows on certain networks such as, for example, The Comedy Channel™ get censored. In addition, many live shows on certain networks such as MTV™ are censored by use of a short time delay. It should be noted that not only are the spoken words of the masters of ceremonies and various speakers beeped and muted, but censorship is also used when inappropriate words are sung as part of a song. Unfortunately, the muting and beeping can be used so much as to make understanding any dialogue or song difficult.

It is sometimes desirable to render a particular television (TV) program in uncensored form. In effect the program may be “unrated” as the actual content of the otherwise censored language is unknown. The producers and performers of the show can decide just how “racy” the uncensored portion of the audio should be. This gives control back to the creators and producers of programs and shows. The viewers can select which version to consume based upon their own preferences and values.

In accord with certain implementations of certain embodiments both a censored and uncensored version of content can be sent to a receiver at the same time with minimal bandwidth cost. The receiver can pick the version that the user wishes to render as it is received based on the user's selection or preference profile. Since only the uncensored content is delivered extra, this can be achieved at very little extra bandwidth cost. To avoid inadvertent playback of uncensored content, a viewer can “opt-in” in order to view the uncensored content or be required to enter a password that unlocks parental control settings, such as those used in a V-chip or equivalent.

In order to achieve this, while tuned to a program or in the process of tuning, a receiver checks the preferences of the viewer. If it is an adult household, the viewer might have selected the uncensored option where available as a default for viewing all television programs. In other instances, the viewer can make the selection on a case by case basis by use of a suitable password so as to temporarily override parental controls that otherwise would prohibit viewing the content at an adult rating.

In general, upon receipt of appropriate instructions from the viewer, the receiver parses the Program Map Table (PMT) to see that an “uncensored” option is available for a show. This means that the primary audio packet ID (PID) is programmed as well as a secondary PID (identifying the packets which will contain the uncensored audio). If uncensored audio is available, it will be sent ahead of the audio it is replacing, in one example. The uncensored audio is selected using the secondary PID, and the censored audio it is replacing will be deleted or ignored (delivered with a packet marked with a primary PID). This substitution can be accomplished using a one-for-one substitution or replacement of the original (censored) content using the technology disclosed in U.S. Pat. No. 7,765,567 issued Jul. 27, 2010 to Candelore, et al. which is hereby incorporated by reference.

Since digital representations of language that is generally censored as being vulgar or otherwise inappropriate is relatively infrequent even when heavily used, these representations account for only a tiny amount of bandwidth. It is estimated to be approximately 0.01% of the bandwidth of the entire program. Yet this small amount of the content could make a big difference as to how a show is perceived and enjoyed. The lack of censorship could be a tremendous marketing feature to a program for certain audiences.

A significant number of the receivers already support Sony Corporation's packet swapping technology as described in the above-referenced patents, particularly if they utilize certain of the integrated circuits currently manufactured by Broadcom Corp. Other receivers can also support fielded set-top boxes either by upgrading the firmware for the soft transport processor or by upgrading the main CPU software (all done through software download mechanisms).

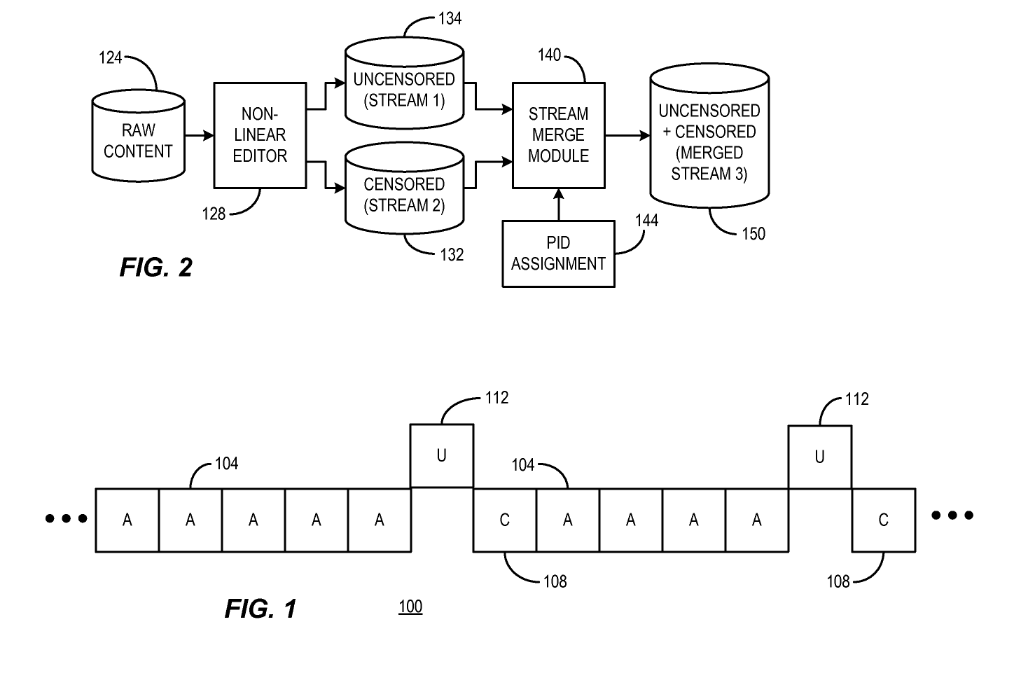

In a scenario contemplated by the discussion above, two sets of audio packets are used to either represent a censored version of certain audio (e.g., silence, beep or an alternative word), where packet substitution is used as described in the above referenced patent. This is depicted in FIG. 1 where a stream 100 is shown having a set of audio packets such as 104 designated “A” (and represented as an audio stream without intervening video or system information packets or packets from another stream for convenience). The packets depicted in the lower horizontal alignment represent packets that, for example, include the same primary packet identifier and include audio packets that are censored with silence or a beep or otherwise and designated “C” such as 108. The upper row of packets designated “U” represent uncensored packets such as 112 that can be substituted for packets 108 to produce an uncensored stream.

In this implementation embodiment, selected packets are substituted to produce uncensored content. However, in an alternative, the entire audio stream can be duplicated. Since audio represents about 5% of overall bandwidth of a television program, it is possible for a service provider to completely duplicate the audio of a program. This would increase the required bandwidth by about 5%. In this implementation, the secondary packet can be used to represent the entire audio stream for uncensored content rather than simply segments thereof.

In an alternative implementation, it may also be possible to send messaging to get a receiver to retune the audio PID to a different one momentarily. However, the messages take time to send out, and switching may not be entirely seamless.

### Creating Censored and Uncensored Content

As discussed above, packet swapping technology can be used in decoder ICs to support a way to create and efficiently decode censored and uncensored content that is transmitted at the same time.

The commercially available Sony VEGAS™ linear editor can be readily adapted to work with the audio segments of interest when enhanced with custom software to manipulate the output to create PASSAGE™ “Cut/Uncut” streams. The resulting stream allows normal receivers, e.g. TVs and set-top boxes, to get the censored audio while enabled receivers can get the un-censored audio if so desired by the home.

The VEGAS™ Pro 10 provides an intuitive and powerful platform to create and produce content. It supports a large number of video and audio codecs, special effects, and editorial tools. Even so called “live events” get some type of post production editing, so editing using Vegas is in keeping with normal content work flows of a studio.

Referring now to FIG. 2, raw uncensored and possibly unedited content 124 is provided to a non-linear editor 128 such as the VEGAS PRO 10 software or other suitable editing process where two almost identical streams are created. One stream 132 is generated with audio censorship and one stream 134 is generated without the audio censorship. The video and audio are trimmed, edited and merged at a stream merge module 140 where special effects may also be inserted. According to certain implementations, the uncensored stream is assigned a secondary packet identifier and the censored stream is assigned a primary packet identifier at a PID assignment module 144 and the streams are merged at 140 to produce the merged stream designated stream 3 at 150.

For the “Uncut” uncensored programming, the stream is “compiled” with no changes to the audio. This creates a transport stream with video and audio packets multiplexed together. This is referred to herein as “Stream 1”. For “Cut” programming, when a content screener wants to censor content, the objectionable audio segments are either replaced with a “beep” segment or the volume level is change to “0”, creating a mute or a substitute word or words are inserted. The stream is then “compiled” with audio changes to create a transport stream with video and audio packets multiplexed together. This streamed is referred to herein a “Stream 2”.

Sony's VEGAS editor allows the screener to easily hear what the resulting audio will sound like. This can be used to assure that the entire objectionable audio is masked and that if “beep” is used, that the volume is suitable.

Custom software at 140 is used to process the two streams to create the third stream at 150, which is referred to herein as “Stream 3”. The Stream 3 has the common video and audio content and the censored/uncensored audio segments interleaved using Sony's Substitution “packet swapping” mode as described in the above patent documents. The program is designed to look for differences in the audio between the two streams. The primary and secondary packet identifiers (PIDs) can be used to distinguish between the censored and uncensored segments or the ordering of packets with the same sequence number can be used as desired, assuming the ordering can be assured at delivery.

The custom software carries out a process of:

### 1—Open Stream 1 and Open Stream 2 for Input, and Open Stream 3 for Output.

2—Read a packet from Stream 1 (censored stream) and Stream 2 (uncensored stream). {If a packet from Stream 2 was written to Stream 3 below, then delete a Null packet.}
3—If the packet from Stream 1 is the same as from Stream 2, write it out to Stream 3 (and go to 5) else proceed back to 1.
4—Write the packet from Stream 2 to Stream 3, and then write the packet from Stream 1 to Stream 3. Go to 1.
5—Check for more packets in Stream 1 and 2. If no more packets then close Stream 1, 2 and 3.

In the preferred implementation, the uncensored audio is delivered using a different packet Identifier (PID) in the transport packet header. This prevents a normal receiver from getting the uncensored audio, unless the customer opts in and the receiver is able to carry out the content substitution to restore the uncensored audio. Using this process, Stream 3 can be quickly and easily be created.

Since language in movies and television programs that some might find objectionable is relatively infrequent, there does not need to be a dedicated audio channel. Substitution mode enabled receivers can readily swap audio content “on the fly” (i.e. as the stream is being processed for reproduction of audio).

### Opting-in

The lack of censorship, to watch a favorite show “uncut” as if seated in the physical audience, could be a tremendous marketing feature to a program. A viewer would preferably “opt-in” in order to view the uncensored content. This means allowing the substitution of the uncensored audio segment for the censored audio segment. If the viewer does not opt-in, the censored audio is received as before.

It is expected that the viewer, in an all adult household, might be actually willing to pay a little extra each month to get “uncut” content. And it is possible that the feature might be used for customer retention purposes.

### Tuning and Decoding

In certain implementations, signaling can be accomplished either using the electronic program guide (EPG) or alternatively using the Enhanced Binary Interchange Format (EBIF). Using the EPG approach, Private data is sent in the Program Map Table (PMT) to signal that a particular program has Cut/Uncut content and the appropriate secondary PID. The particular PMT with the private data can be selected from the guide as a “separate program” with different parental control rating.

With EBIF, the tuning can be done with an app that is downloaded with the program. It could also benefit from the EPG method for signaling parental control and tuning or it can have its own mechanism for evaluating parental control ratings and program the secondary PIDs during tuning.

This process permits sending censored and uncensored content at the same time while not violating the sensibilities or values of some viewers. The approach ties into the existing parental control system and uses signaling to allow a viewer to select between different parental control versions of the same content.

In the approaches above, the process relies on delivery of “structured” transport streams and the receiver implementing “packet swapping” functionality as provided for in Sony's Passage™ technology as described in the above referenced patent documents. Legacy receivers will continue to tune Cut Content (sent as primary packets) by virtue of tuning and decoding only primary packet ID (PID) packets. Enabled receivers will tune both Cut and Uncut content (sent as primary and secondary packets) by tuning both primary and secondary PID packets. When secondary packets are received they are swapped in place of the primary packet and decoded.

When tuning a channel, a receiver first obtains the Program Map Table (PMT) which lists the primary video and audio packet IDs (PIDs). For the Cut/Uncut application, in the audio loop of the PMT, the secondary PID for the Uncut audio is obtained through a private Cut/Uncut descriptor such as the following:

| Syntax | No. of Bits | Values | Format |
|---|---|---|---|
| Cut-Uncut_descriptor( ) { | | | |
| descriptor_tag | 8 | 0xC5 | uimsbf |
| descriptor_length | 8 | | uimsbf |
| reserved | 3 | | bslbf |
| elementary_PID | 13 | | uimsbf |
| For (i=0, i<N,i++){ | 8 | | bslbf |
| additional_data | | | |
| } | | | |
| } | | | |

The additional_data field shown in this example is optional. It can contain information regarding the secondary audio. For instance, it can convey rating information. Alternatively, it could distinguish the audio type, e.g. a racial slurs, profanities, or gratuitous religious references. It is possible to delivery different uncensored audio using different PIDs. Certain receivers can support multiple secondary audio PIDs at the same time, if so a receiver could distinguish between different uncensored audio using the additional data field, allowing certain audio but not some other audio because it disturbs the sensibilities of a particular viewer or listener. In the discussion below, however, we will simple use a single descriptor for the purposes of clarity.

The Cut/Uncut descriptor can be inserted at content creation and it is maintain throughout distribution. It is sent to all receivers trying to tune the content. Receivers that don't know about the descriptor, that are not enabled for Cut/Uncut, or that have not selected Uncut content simply ignore it.

EBIF may also be used as an alternative way to tune the content without modifying entries in the EPG. Operators such a Comcast and Time Warner are deploying EBIF applications linked to television shows for advertising and additional information to a receiver, e.g. stats for a baseball game, etc. It is possible to stream an EBIF app that creates a dialogue box with the user questioning whether the user wishes to view an uncut version of the content. If the user clicks “yes”, then a parental control screen may be brought up or the content could just be rendered

Several options are possible using the EBIF approach. In one option an additional, second program description and PMT description could include Cut/Uncut Descriptor and would be parentally controlled. The EBIF can then be used to interpret parental control information and to select this second program. It is likely that EBIF would not need to be modified . . . only low-level set-top box tuning. The low-level set-top box tuning functionality would interpret the Cut/Uncut descriptor to program the secondary PID. This technique may require set-top box vendor and service operator support.

In the above EPG option, a Different Virtual Channel is presented to user as “Uncut” Program. In the EBIF option, the app can be used to select, for example, Program 11 instead of, for example, Program 1 (PID 11 rather than PID 1) for a dialogue even if Program 11 is not actually shown in the EPG using a Virtual Channel Table (VCT). In this example, Video and Audio primary PIDs are the same with Program 1 and Program 11. The Uncut channel has a secondary PID (Program 11) descriptor for audio, and Program 11 can have different parental control than Program 1. In both approaches, EPG and EBIF as described above may require a change to set-top box tuning software.

In another option, the EBIF application programs the secondary PID from the app itself. This could require the EBIF app to write to low-level registers. In this scenario, the low-level drivers of the set-top box might remain unchanged. Application is linked to a particular program, interacts with the user, and tunes the secondary PID directly. EBIF Dialogue should be conditional on whether receiver can support Cut/Uncut programming as taught herein, and it is noted that EBIF may be platform dependent.

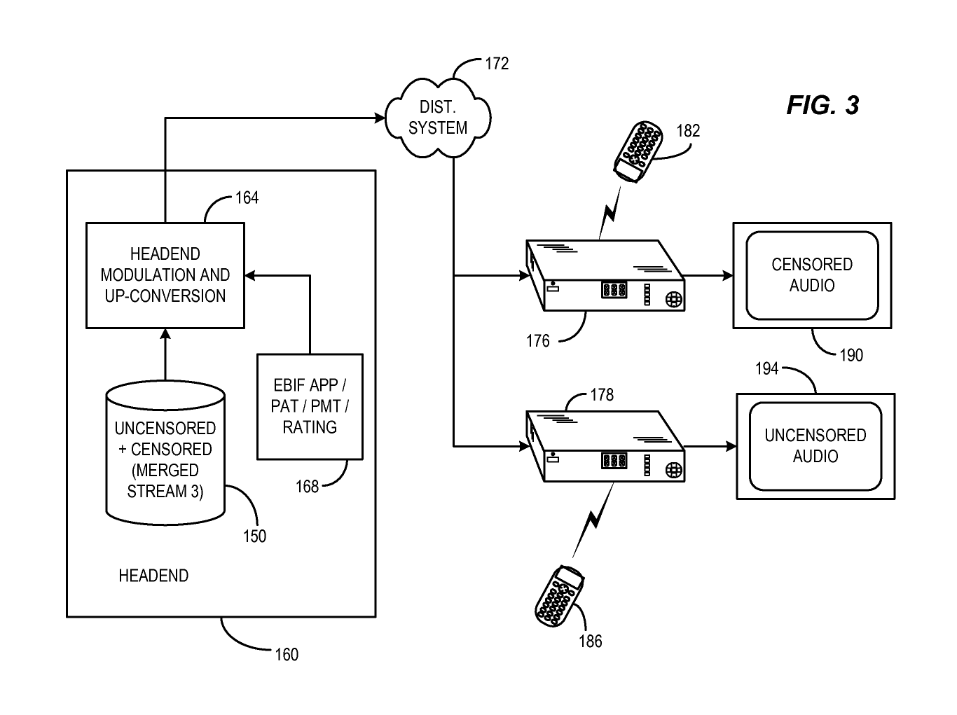

Referring now to FIG. 3, the merged stream 3, designated 150, is provided by a headend 160, which can be a cable television headend, a satellite television headend, or a source on the Internet. The merged stream 150 is provided to the headend's modulation and up conversion system 164 where it is combined with an EBIF app if necessary, a program association table, a program map table rating information, and other system information (or service information) that supports the particular form of distribution and reproduction. This additional information is added at 168. Once the merged stream is modulated and transmitted, it is provided to a distribution system 172, such as the Internet, a cable television network, or a satellite distribution system. The content can then be received at receivers, such as 176 and 178, which operate using remote controllers, such as 182 and 186. In the case of receiver 176, only the primary PID content is depicted, and censored audio is played at the television receiver 190. However, as depicted, the receiver 178 is instructed to operate utilizing both the audio in the primary PID, as well as by substitution of the audio in the secondary PID so as to provide uncensored audio at television set 194.

Those skilled in the art will appreciate upon consideration of the present teachings that while a receiver, such as 176 or 178, is depicted in conjunction with television sets 190 and 194 respectively, the capabilities of receivers 176 and 178 may be integrated into televisions 190 and 194 in certain implementations.

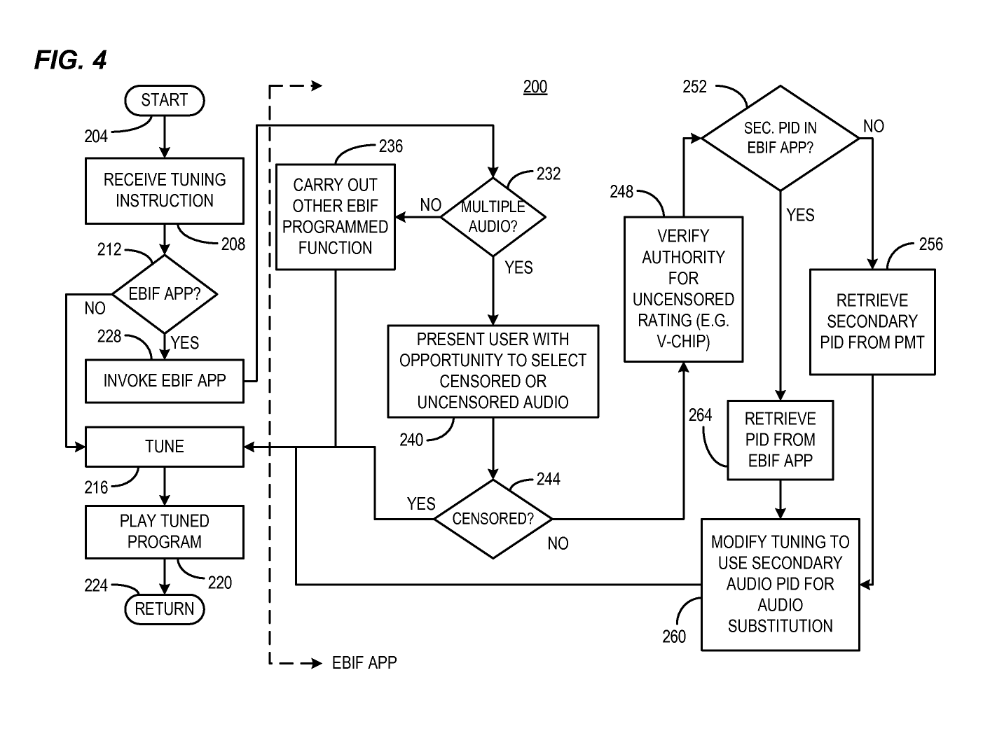

Referring now to FIG. 4, a process 200 is depicted, which utilizes and EBIF app to carry out one implementation of the process consistent with certain embodiments of the present invention. Process 200 starts at 204 after which a tuning instruction is received at 208. Upon receipt of the tuning instruction at 208, a determination is made at 212 as to whether or not an EBIF app is incorporated into the program stream which is being tuned. If no EBIF app is present at 212, then the program is tuned at 216 and the tuned program is played at 220. The process ends or returns at 224.

However, if an EBIF app is present at 212, the EBIF app is invoked at 228 and a determination is made at 232 as to whether or not multiple audio streams are available in censored and uncensored form. If multiple audio streams are not present and the EBIF app is to carry out other functions, these other functions are carried out at 236, and the process returns to 216. However, if the multiple audio programs are available to 232, the user may be presented with an opportunity to select between censored or uncensored audio at 240 (assuming this determination has not been made at the time of a television setup as an opt-in or opt-out). At 244, if the user selects censored audio, the process returns to 216 and normal tuning is carried out. However, if the user selects uncensored audio at 244, the user is first verified to determine that he has authority to view the uncensored rated programming, for example, by use of V-chip privileges at 248 or possibly by entry of a password. Assuming that the user does in fact have authority to view uncensored content at 248, the process proceeds to 252 where the secondary PID is identified as being either in the EBIF app or not. (This option is shown for convenience, but may be hard-coded in the EBIF app for one or the other depending upon the nature of the system.) While not shown, if the user is not authorized at 248, the process simply returns to 216 for viewing the censored content.

If the EBIF app does not contain the audio content associated with the secondary PID or does not contain an identifier for the secondary PID at 252, then this information is retrieved from the program map table at 256, and the tuning is modified accordingly to use the secondary audio PID for audio substitution at 260. After 260, the process returns to 216 where the content is tuned utilizing both primary and secondary PIDs in order to obtain the uncensored audio content. However, if the secondary PID is identified in EBIF app at 252, then the PID is retrieved from the EBIF app at 264, and the process proceeds to 260 so that the tuning can be modified to utilize the secondary audio PID for audio substitution. In the process 200 depicted in FIG. 4, the operations carried out within the EBIF app in the particular implementation described is shown to the right of the dashed arrowed lines.

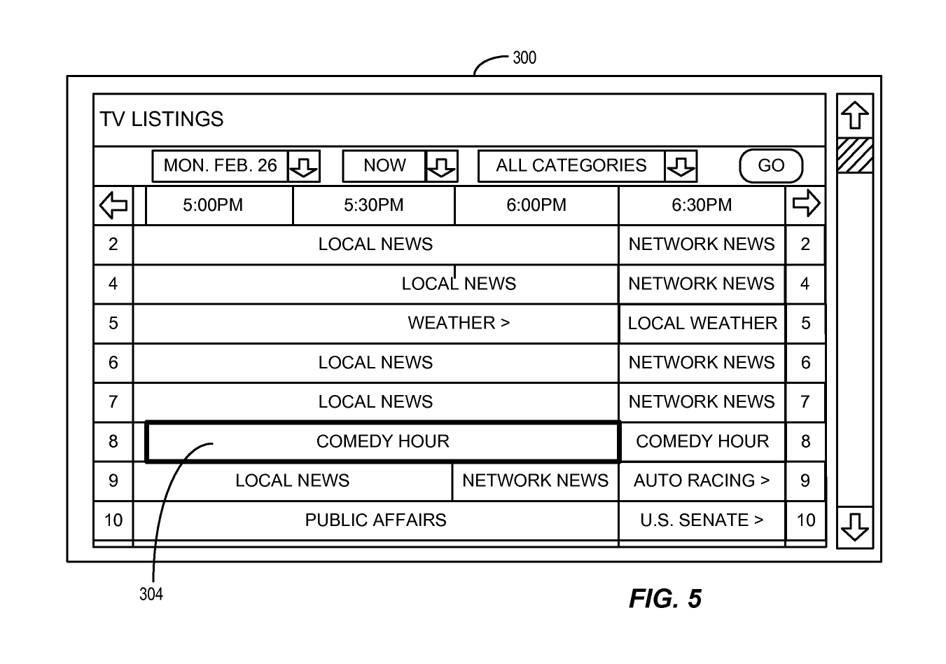

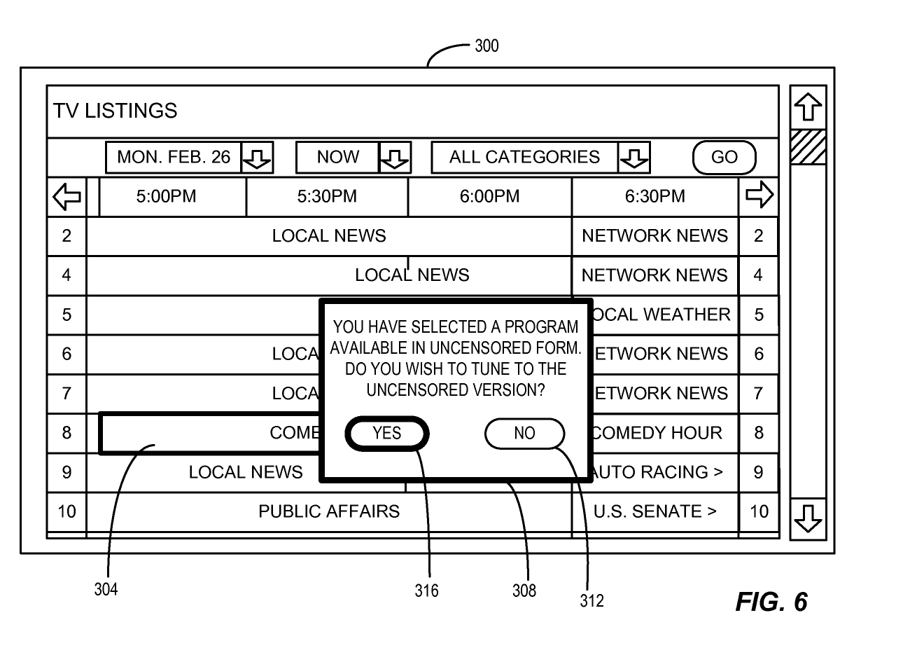

Therefore, in one embodiment as depicted herein, a program guide, such as that depicted in FIG. 5 as 300, depicts a set of program listings wherein the user can select a program to be tuned and viewed, such as program 304. When this selection is made, the user may be presented with a window 308 as shown in FIG. 6, which asks the user if he wishes to tune to an uncensored version of the selected content. The user can either select “no” at 312, in which case the program continues to play in the censored mode, or the viewer can select 316, which selection implements play of the uncensored version of the content.

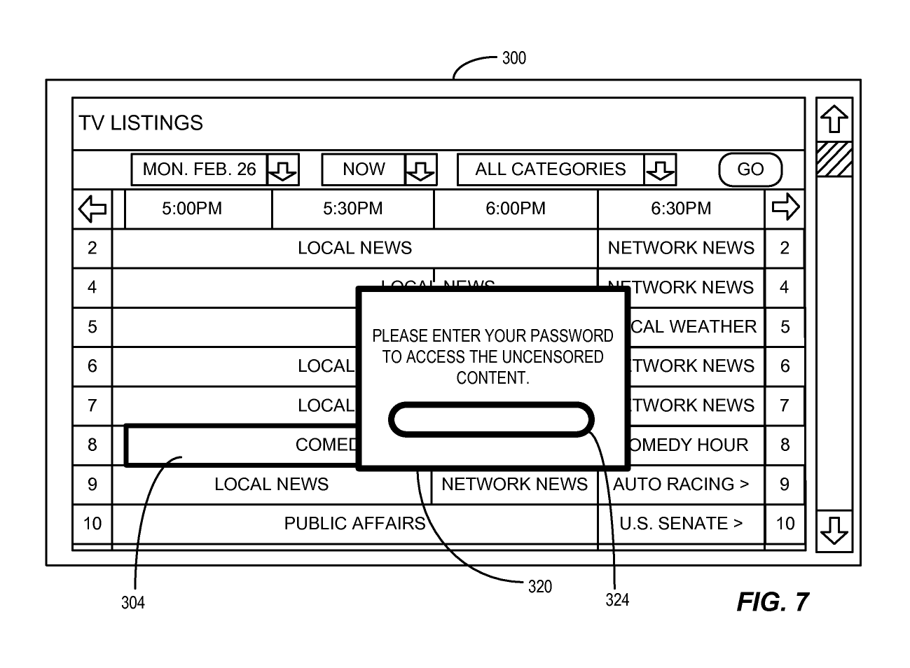

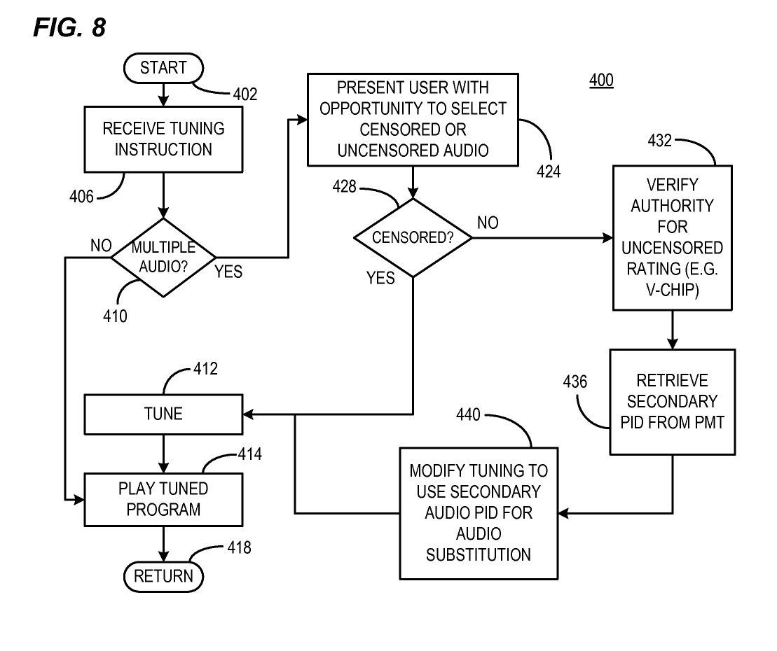

With reference to FIG. 7, if the user elects to view the uncensored version of the content, a window is provided at 320 in one embodiment in which the user is permitted to enter a password in order to access the uncensored content at 324. In other implementations, if the household is a completely adult household, for example, a password may not need to be entered since parental controls have not been implemented or a default opt-in may have been elected at the time the television receiver device is set up.

Referring now to FIG. 8, an alternative implementation is depicted as 400 starting at 402. At 406, a tuning instruction is received from the user. The television processor then determines whether or not the selected program associated with the tuning instruction is one that contains multiple audio content at 410. If not, the content can be tuned at 412 and the tuned program can be played at 414. The process then ends or returns at 418.

If at 410 it is determined that multiple audio programs exist, then the process proceeds to 424 where the user is presented with an opportunity to select censored or uncensored audio (again, except if there has been a global opt-in by virtue of the television receiver device setup). If the user selects censored audio, the process proceeds to 412 and the program is tuned and played as previously described. However, if the user elects to view the uncensored content at 428, the process proceeds to 432 where the user is again verified for authorization to view uncensored content, for example, by use of parental controls such as those provided in a V-chip. Once the user is verified as authorized to view uncensored content, the secondary PID is retrieved from the program map table at 436, and the tuning is modified at 440 to utilize the secondary audio PID, in addition to the primary audio PID in an audio substitution mode of operation after which the program can be tuned at 412 to utilize both the primary and secondary PIDs. Again not shown, the process is taken to 412 if the user is not authenticated at 432.

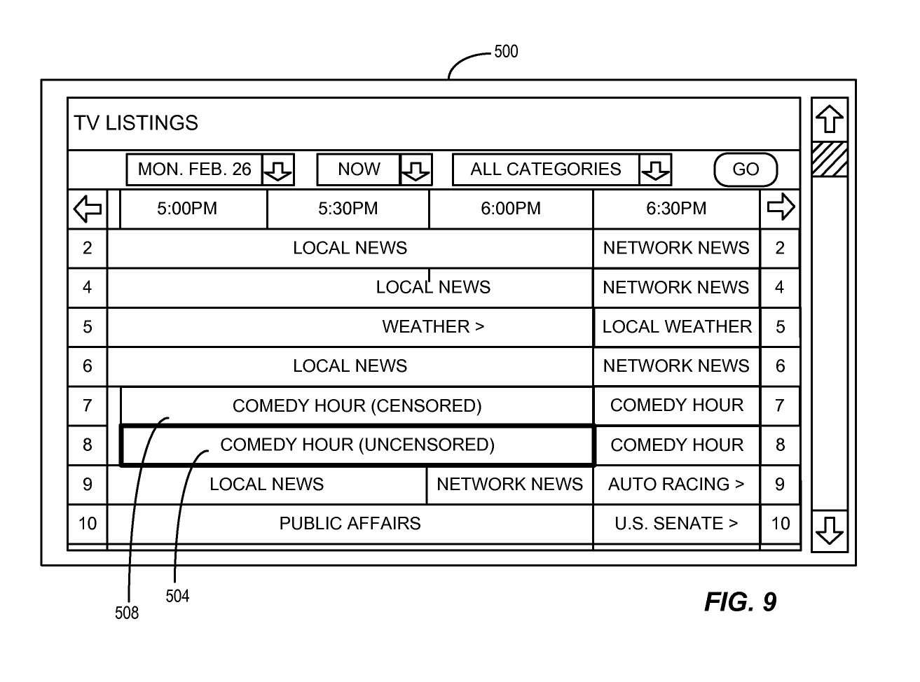

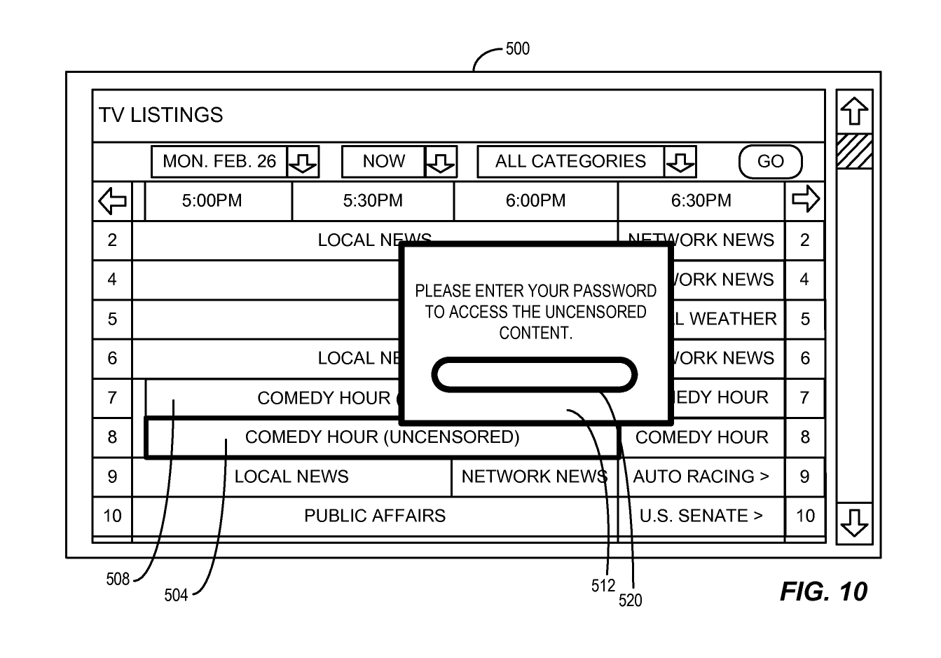

In another implementation, a program guide, such as 500 of FIG. 9, can be retrieved by the user and the program guide can list both censored and uncensored versions of a program, such as uncensored version 504 and censored version 508 as depicted. In this manner, the user directly selects the version desired. Referring to FIG. 10, once the user selects an uncensored version of the content, the user may be presented with a window 512 in which the user is required to enter a password at 520 in order to access the uncensored content. However, again when the household is made up entirely of adults and the adults have opted-in to always being able to view uncensored content, the uncensored content can be immediately tuned.

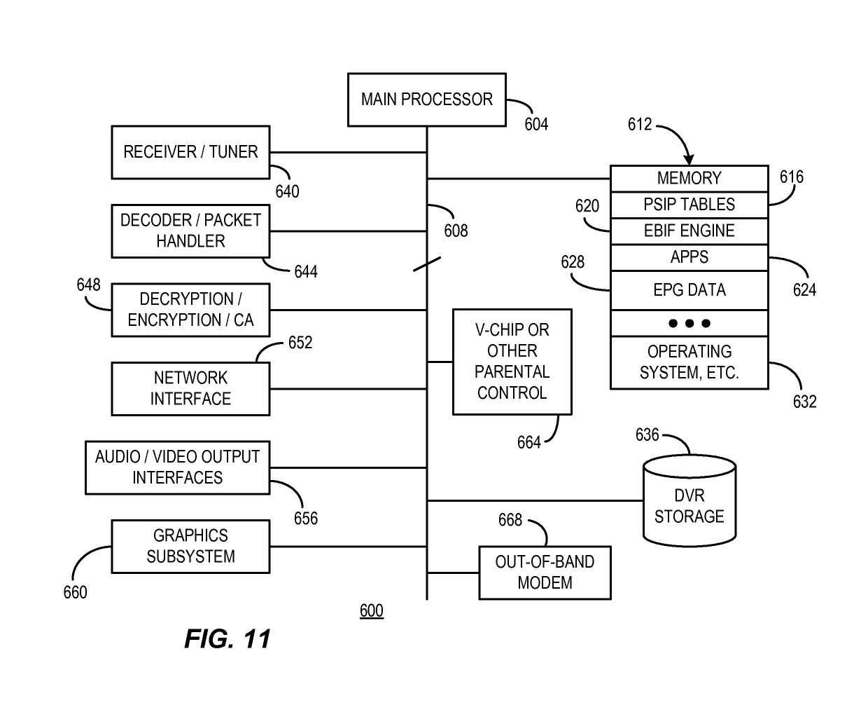

Referring now to FIG. 11, a television receiver device 600 suitable for implementing the present process is depicted. It will be appreciated by those skilled in the art upon consideration of the present teachings that system 600 may represent a single television receiver device or multiple devices used together, such as, for example, a television set top box used in conjunction with a television receiver or alternatively a television receiver that incorporates all of the capabilities of a television set top box, including the processor with an ability to execute EBIF applications. In accord with system 600, a main processor or processors 604 is provided, which connects using multiple or single bus structures, such as 608 (depicted as a single bus for simplicity) in order to communicate with various elements of hardware, including memory 612, which incorporates, for example, PSIP tables 616, EBIF execution engine 620, applications (apps) 624, EPG data 628, operating system 632, etc. System 600 may incorporate a digital video recorder storage feature, such as 636 optionally. The receiver includes a receiver and tuner 640 suitable for tuning to broadcast television, satellite television, cable television, internet television, or any combination of the above. A decoder and packet handler 644 decodes incoming data in the form of data packets and carries out the content substitution functions described.

When content is encrypted, decryption and encryption and conditional access can be handled at a crypto module 648. A network interface 652 is provided to permit communication over wired or wireless networks as needed. Various audio and video outputs can be provided at 656 for providing output in various formats, including HDMI and analog. A graphic sub system 660 is utilized to generate overlays and other graphics that render pop-up windows, electronic program guides, and other graphics. A V-chip 664 is provided for implementing parental control or other hardware or software based parental control mechanisms can be programmed. An out of band modem 668 may be provided for receipt of IPTV (Internet Protocol Television) or other data exchange and Internet connectivity in certain implementations such as cable television receiver devices. Other components have been omitted for clarity which those skilled in the art will understand may be used in certain content delivery environments.

It will be appreciated by those skilled in the art that the present system can be implemented as a television device of any sort, including a television set or television set including set top box like functionality. It is also noted that one skilled in the art will recognize upon consideration of the present teachings that the use of the PSIP term “system information” or “SI” is intended to be equivalent to “service information” or information having similar functions with whatever environment is utilized for conveying the content from a source to a user device.

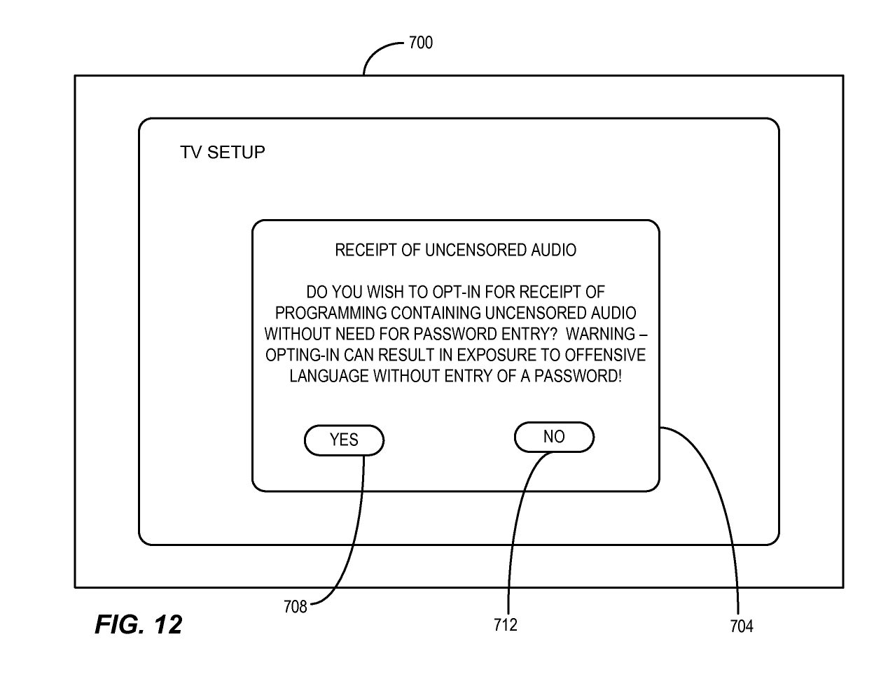

Referring now to FIG. 12, as has been noted above, one may elect to “opt-in” for receipt of uncensored content by simply tuning to the content by use of any suitable mechanism as a part of a setup process. One such mechanism is depicted as screen 700 of FIG. 12 in which, as a part of a television setup process (which may require a password for entry), the user is provided with a setup screen 704 that permits op-in for receipt of uncensored audio. In this case, a warning is provided so as to assure that the user understands that this could result in exposure to offensive language. In this example, the user opts-in by selecting 708 and opts-out by selecting 712. A factory setup may include opting-out unless the user explicitly opts-in to avoid inadvertent exposure to offensive language.

Thus, in certain implementations, a television receiver device has an interface configured to receive audio video (A/V) program content and tuning information. A processor is programmed to: tune to a designated program; present an option to tune to the designated program with either a censored or uncensored version of audio; upon receipt of an instruction to tune to the designated program with uncensored audio, tune to a substitute audio stream identified with a secondary packet identifier, where the substitute audio stream substitutes uncensored segments of audio for censored segments of audio.

In certain implementations, the uncensored segments of audio are identified within system information as a separate program having the secondary packet identifier. In certain implementations, In certain implementations, a portion of the tuning information is received in an Enhanced Binary Interchange Format (EBIF) app. In certain implementations, the EBIF app is received as data forming a part of the designated program. In certain implementations, the EBIF app programs the tuning of the television receiver device to receive the uncensored segments of audio. In certain implementations, the EBIF app programs tuning of the television receiver to a packet identifier contained within the EBIF app. In certain implementations, the EBIF app programs tuning of the television receiver to a packet identifier designated within system information. In certain implementations, the option to tune to an uncensored version of the audio is made in advance of tuning by use of an opt-in selection forming a part of the television receiver device setup.

Another television receiver device has an interface configured to receive audio video (A/V) program content and tuning information. A processor is programmed to: tune to a designated program; receive and execute an Enhanced Binary Exchange Format (EBIF) app; under control of the EBIF app, present an option to tune to the designated program with either a censored or uncensored version of audio; upon receipt of an instruction to tune to the designated program with uncensored audio, tune to a substitute audio stream identified with a secondary packet identifier, where the substitute audio stream substitutes uncensored segments of audio for censored segments of audio.

In certain implementations, the uncensored segments of audio are identified within system information as a separate program having the secondary packet identifier. In certain implementations, a portion of the tuning information is received in an EBIF app. In certain implementations, the EBIF app is received as data forming a part of the designated program. In certain implementations, the EBIF app programs the tuning of the television receiver device to receive the uncensored segments of audio. In certain implementations, the EBIF app programs tuning of the television receiver to a packet identifier contained within the EBIF app. In certain implementations, the EBIF app programs tuning of the television receiver to a packet identifier designated within system information.

A television receiver device has an interface configured to receive audio video (A/V) program content and tuning information. A processor is programmed to: tune to a designated program; receive and execute an Enhanced Binary Exchange Format (EBIF) app; under control of the EBIF app, tune to the designated program with either a censored or uncensored version of audio; upon receipt of an instruction to tune to the designated program with uncensored audio, tune to a substitute audio stream identified with a secondary packet identifier, where the substitute audio stream substitutes uncensored segments of audio for censored segments of audio; and where the EBIF app programs the tuning of the television receiver device to receive the uncensored segments of audio.

In certain implementations, the uncensored segments of audio are identified within system information as a separate program having the secondary packet identifier. In certain implementations, a portion of the tuning information is received in an EBIF app. In certain implementations, the EBIF app is received as data forming a part of the designated program. In certain implementations, the EBIF app programs tuning of the television receiver to a packet identifier contained within the EBIF appIn certain implementations, the EBIF app programs tuning of the television receiver to a packet identifier designated within system information. In certain implementations, the instruction to tune to an uncensored version of the audio is made in advance of tuning by use of an opt-in selection forming a part of the television receiver device setup.

Those skilled in the art will recognize, upon consideration of the above teachings, that certain of the above exemplary embodiments are based upon use of one or more programmed processors programmed with a suitable computer program. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using one or more programmed processors executing programming instructions that are broadly described above in flow chart form that can be stored on any suitable electronic or computer readable storage medium such as a non-transitory storage medium (where non-transitory is intended to only distinguish over transitory propagating signals and not to exclude erasable or non-volatile storage devices). However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping, time outs, etc. can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A television receiver device, comprising:
an interface configured to receive audio video (A/V) program content and tuning information;
a processor programmed to:
tune to a designated program;
present an option to tune to the designated program with either a censored or uncensored version of audio;
upon receipt of an instruction to tune to the designated program with uncensored audio, tune to a substitute audio stream identified with a secondary packet identifier, where the substitute audio stream substitutes uncensored segments of audio for censored segments of audio.

2. The television receiver device according to claim 1, where the uncensored segments of audio are identified within system information as a separate program having the secondary packet identifier.

3. The television receiver device according to claim 1, where a portion of the tuning information is received in an Enhanced Binary Interchange Format (EBIF) app.

4. The television receiver device according to claim 3, where the EBIF app is received as data forming a part of the designated program.

5. The television receiver device according to claim 3, where the EBIF app programs the tuning of the television receiver device to receive the uncensored segments of audio.

6. The television receiver device according to claim 3, where the EBIF app programs tuning of the television receiver to a packet identifier contained within the EBIF app.

7. The television receiver device according to claim 3, where the EBIF app programs tuning of the television receiver to a packet identifier designated within system information.

8. The television receiver device according to claim 1, where the option to tune to an uncensored version of the audio is made in advance of tuning by use of an opt-in selection forming a part of the television receiver device setup.

9. A television receiver device, comprising:
an interface configured to receive audio video (A/V) program content and tuning information;
a processor programmed to:
tune to a designated program;
receive and execute an Enhanced Binary Exchange Format (EBIF) app;
under control of the EBIF app, present an option to tune to the designated program with either a censored or uncensored version of audio;
upon receipt of an instruction to tune to the designated program with uncensored audio, tune to a substitute audio stream identified with a secondary packet identifier, where the substitute audio stream substitutes uncensored segments of audio for censored segments of audio.

10. The television receiver device according to claim 9, where the uncensored segments of audio are identified within system information as a separate program having the secondary packet identifier.

11. The television receiver device according to claim 9, where a portion of the tuning information is received in an EBIF app.

12. The television receiver device according to claim 9, where the EBIF app is received as data forming a part of the designated program.

13. The television receiver device according to claim 9, where the EBIF app programs the tuning of the television receiver device to receive the uncensored segments of audio.

14. The television receiver device according to claim 9, where the EBIF app programs tuning of the television receiver to a packet identifier contained within the EBIF app.

15. The television receiver device according to claim 9, where the EBIF app programs tuning of the television receiver to a packet identifier designated within system information.

16. A television receiver device, comprising:
an interface configured to receive audio video (A/V) program content and tuning information;
a processor programmed to:
tune to a designated program;
receive and execute an Enhanced Binary Exchange Format (EBIF) app;
under control of the EBIF app, tuning to the designated program with either a censored or uncensored version of audio;
upon receipt of an instruction to tune to the designated program with uncensored audio, tune to a substitute audio stream identified with a secondary packet identifier, where the substitute audio stream substitutes uncensored segments of audio for censored segments of audio; and
where the EBIF app programs the tuning of the television receiver device to receive the uncensored segments of audio.

17. The television receiver device according to claim 16, where the uncensored segments of audio are identified within system information as a separate program having the secondary packet identifier.

18. The television receiver device according to claim 16, where a portion of the tuning information is received in an EBIF app.

19. The television receiver device according to claim 16, where the EBIF app is received as data forming a part of the designated program.

20. The television receiver device according to claim 16, where the EBIF app programs tuning of the television receiver to a packet identifier contained within the EBIF app.

21. The television receiver device according to claim 16, where the EBIF app programs tuning of the television receiver to a packet identifier designated within system information.

22. The television receiver device according to claim 16, where the instruction to tune to an uncensored version of the audio is made in advance of tuning by use of an opt-in selection forming a part of the television receiver device setup.
